(19) United States
(12) Patent Application Publication
(10) Pub. No.: US 2024/0310015 A1
(43) Pub. Date: Sep. 19, 2024

(54) VEHICLE LIGHTING DEVICE

(71) Applicant: Hella Saturnus Slovenija d.o.o., Ljubljana (SI)

(72) Inventors: Bostjan Berkopec, Straza (SI); Gregor Bensa, Nova Gorica (SI); Nejc Jezersek, Domzale (SI); Ursa Lokar, Ljubljana (SI)

(21) Appl. No.: 18/675,963

(22) Filed: May 28, 2024

Related U.S. Application Data
(63) Continuation of application No. PCT/EP2021/083475, filed on Nov. 30, 2021.

(51) Int. Cl. F21S 41/24; F21S 41/143; F21S 41/147

(52) U.S. Cl. CPC F21S 41/24; F21S 41/143; F21S 41/147; G02B 6/0036

(57) ABSTRACT

A vehicle lighting device includes a main lighting module for light radiation along a main radiation direction, and a secondary lighting module with a light source and a light guide component. The light source radiates light into the light guide component via an end face. The light guide component includes outcoupling elements protruding at the rear side for light outcoupling out of the opposite front side of the light guide component. The light guide component is in front of the main lighting module such that at least a part of the light guide component is within the field of view of the main lighting module. The outcoupling elements has a truncated shape with plane end faces. The plane end faces are oriented parallel to the front side of the light guide component and/or perpendicular to the main radiation direction and/or inclined in an intermediate orientation.

### CROSS REFERENCE

This application claims priority to PCT Application No. PCT/EP2021/083475, filed Nov. 30, 2021, the entirety which is hereby incorporated by reference.

### FIELD OF THE INVENTION

The present invention relates to a vehicle lighting device featuring a main lighting module and a secondary lighting module with a light guide component.

### BACKGROUND OF THE INVENTION

Vehicle lighting devices are increasingly equipped with lighting modules featuring light guide components, also called optical waveguides, with elongated extension as central lighting elements, the lateral surfaces of which are used for the outcoupling of light. For example, DE 10 2012 108 855 A1 discloses a light guide component for a vehicle lighting module with a light coupling section for coupling light into one or both ends of the light guide component and with a main section with a front side for light output and a rear side with outcoupling elements for deflecting the light towards the front side. The light guidance along the light guide component is in particular based on the principle of total reflection, and in the prior art it is common to form the outcoupling elements on the rear side of the light guide component, for example, in the shape of pyramids, ellipsoidal segments or other free-form bodies, or to realise the outcoupling elements by macroscopical roughness of the rear surface of the light guide component.

In particular, the aesthetically pleasing appearance of illuminated light guide components is exploited for the individual design of lighting devices. For example, headlights are known in which a light guide component runs around a main lighting module, in particular a low beam or high beam module, forming a distinctive, curved contour. In this case, the light guide component can be arranged at least in sections within the border area of the field of view of the main lighting module, so that light emitted during operation of the main lighting module passes through the light guide component in the transverse direction. The problem arises that the outcoupling elements on the rear side of the light guide component facing the main lighting module lead to scattering and refraction of the light radiated by the main lighting module, so that the overall light impression of the lighting device is undesirably adversely affected.

### BRIEF SUMMARY OF THE INVENTION

It is an object of the present invention to propose a vehicle lighting device with a main lighting module and a secondary lighting module with a light guide component, in which the light guide component is arranged within the field of view of the main lighting module, and which is characterized in particular by essentially undisturbed beam propagation of light radiated by the main lighting module when passing transversally through the light guide component. In the context of the present invention, the field of view of the main lighting module is understood to be the radiation area, i.e., the spatial area into which the main lighting module radiates light during operation.

The invention discloses the technical teaching that the outcoupling elements at the rear side of the light guide component feature truncated shapes with plane end faces, the plane end faces being oriented parallel to the front side of the light guide component and/or perpendicular to the main radiation direction of the main lighting module and/or inclined in an intermediate orientation.

The basic idea of the invention is to provide the outcoupling elements with plane end faces and to align these with respect to the main radiation direction of the main lighting module in such a way that scattering and refraction occur only to a comparatively small extent during the transverse passage of light through the light guide component. The plane end faces of the outcoupling elements are preferably oriented parallel to the front side of the light guide component and perpendicular to the main radiation direction, so that light propagating along the main radiation direction does not experience any deflection. If the front side of the light guide component is not oriented perpendicular to the main radiation direction, only a slight parallel shift of the transmitted light occurs. Furthermore, the orientation of the plane end faces of the outcoupling elements can deviate from a parallel alignment to the front side of the light guide component and, in particular, can be directed perpendicular to the main radiation direction. Generally, any intermediate orientation of the plane end faces of the outcoupling elements can be suitable within the scope of the invention, i.e., any inclination of the plane end faces between an alignment parallel to the front side of the light guide component and a perpendicular orientation to the main radiation direction. For example, a dedicated light deflection effect for light emitted along the main radiation direction can be implemented by suitable orientation of the plane end faces of the outcoupling elements, which can be particularly useful for the peripheral areas of the field of view of the main lighting module.

The modification of the shape of the outcoupling elements according to the invention can have a detrimental effect on the outcoupling efficiency of light guided within the light guide component, so that in the specific application a suitable compromise must be formed in each case, which ensures an undisturbed passage of the light radiated by the main lighting module on the one hand and a sufficient light outcoupling from the light guide component on the other hand each to the required extent. For this purpose, in particular the extent of the truncation of the outcoupling elements can be suitably selected and/or there can be a dedicated variation in the detailed shape, dimensions and spacing of the outcoupling elements along the light guide component. In particular, the orientation of the plane end faces of the outcoupling elements relative to the main radiation direction of the main lighting module may also vary along the light guide component.

The light guide component is preferably made of silicone, PMMA, PC or any other light transmitting material, in particular by means of an injection moulding process.

In preferred embodiments, the outcoupling elements feature the shape of truncated cones, truncated pyramids, truncated hemispheres, truncated ellipsoidal segments and/or truncated free-form bodies, the plane end faces being formed by the truncation. As mentioned above, the shape and dimensions of the outcoupling elements should be adapted to the specific requirements of the respective vehicle lighting device of use, for example, the shape of the outcoupling elements can also vary along the light guide component.

Furthermore, the orientation of the plane end faces with respect to the main radiation direction of the main lightning module and/or with respect to the front side of the light guide component may vary among the outcoupling elements. For example, the light guide component features an elongated, curved shape in such a way that the orientation of the front side and the orientation of the plane end faces of the outcoupling elements vary along the elongation of the light guide component with respect to the main radiation direction.

In particular, the outcoupling elements protrude at the rear side of the light guide component by a height in the range of 0.05 mm to 5 mm and/or the outcoupling elements feature a lateral size in the range of 0.05 mm to 5 mm. These dimensions allow individual configurability and adaptability of the outcoupling elements to the respective lighting functions to be fulfilled; furthermore, components of these dimensions can be conveniently produced using common injection moulding processes.

The body of the light guide component for instance features the shape of a rod, a plate or a free-form body. The basic idea of the present invention is applicable to waveguides of essentially any shape, so that the shape of the body of the light guide component can be chosen according to the specific application. In particular, the body of the light guide component can be bent or feature a curved shape. If the light guide component features a curved front side, the local surface normal provides the reference orientation for the alignment of the plane end faces of the associated outcoupling elements.

Exemplarily, the vehicle lighting device is designed as a vehicle headlight and the main lighting module is designed as a low-beam lighting module.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 is a schematic cross-sectional view of a prior art vehicle lighting device.

FIGS. 2a, 2b are schematic cross-sectional views of a first embodiment of the vehicle lighting device according to the invention.

FIG. 3 is a schematic cross-sectional view of a second embodiment.

FIG. 4 is a schematic cross-sectional view of a third embodiment.

FIG. 5 is a schematic cross-sectional view of a light guide component according to the invention.

### DETAILED DESCRIPTION OF THE DRAWINGS

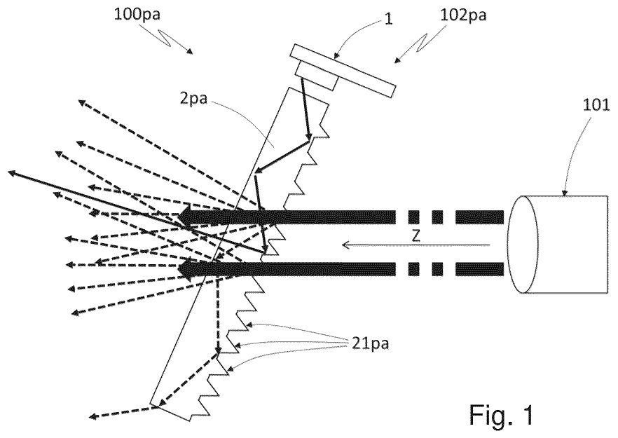

FIG. 1 shows a schematic cross-sectional view of a part of a prior art vehicle lighting device 100pa. This features the main lighting module 101 and the secondary lighting module 102pa, which comprises the light source 1 and the light guide component 2pa, the light guide component 2pa being arranged in sections within the field of view of the main lighting module 101, so that light emitted by the main lighting module 101 about the main radiation direction Z (thick arrows) passes through the light guide component 2pa. The light guide component 2pa features conical outcoupling elements 21pa which serve to decouple, i.e., deflect the light of the light source 1 propagating within the light guide component 2pa (thin, solid arrows). The tips of the outcoupling elements 21pa act as scattering centres for the incident light of the main light module 101 and the flanks of the outcoupling elements 21pa produce light deflection by refraction (dashed arrows). The task underlying the present invention is to significantly reduce the interference of the light of the main lighting module 101 passing transversely through the light guide component 2pa by the outcoupling elements 21pa.

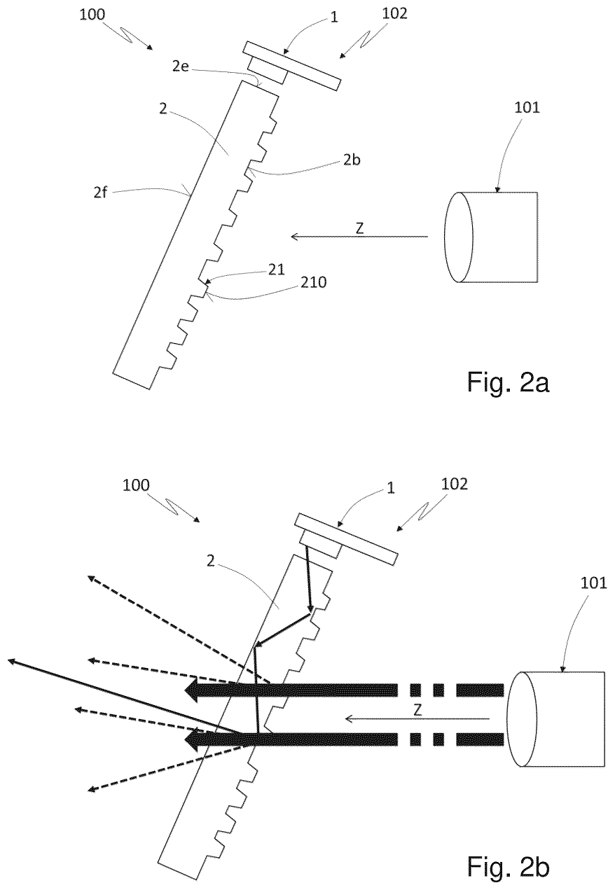

FIG. 2a shows a schematic cross-sectional view of a part of a first embodiment of the vehicle lighting device 100 according to the invention. The vehicle lighting device 100 features the main lighting module 101 for light radiation along the main radiation direction Z, and the secondary lighting module 102 with the light source 1 and the light guide component 2, the light source 1 being set up to radiate light into the light guide component 2 via the end face 2e and the light guide component 2 featuring outcoupling elements 21 protruding at the rear side 2b for light outcoupling out of the opposite front side 2f of the light guide component 2. The light guide component 2 is arranged in front of the main lighting module 101 in such a way that at least a part of the light guide component 2 is arranged within the field of view of the main lighting module 101. According to the invention, the outcoupling elements 21 feature truncated shapes with plane end faces 210, the plane end faces 210 being oriented parallel to the front side 2f of the light guide component 2. The shape of the outcoupling elements 21 is based on cones, and the plane end faces 210 are introduced by truncation of said cones.

FIG. 2b shows a representation corresponding to FIG. 2a, in which simplified schematic light beam paths are sketched. The undesired light scattering or refraction (dashed arrows) during the transverse passage of the light emitted by the main lighting module 101 (thick arrows) is significantly reduced in comparison to a corresponding prior art lighting device (see FIG. 1), since the outcoupling elements 21 are truncated with the plane end faces 210, which neither act as strong scattering centres nor contribute to pronounced refraction.

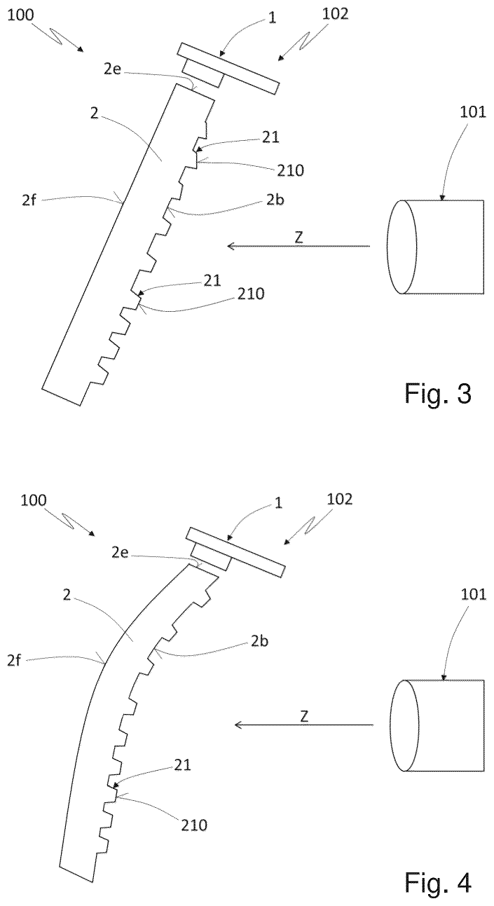

FIG. 3 and FIG. 4 show schematic cross-sectional views of a second and a third embodiment, respectively, of the vehicle lighting device 100 according to the invention, the reference signs corresponding to those mentioned above in connection with the description of FIG. 2a.

In the embodiment of FIG. 3, the orientation of the plane end faces 210 with respect to the main radiation direction Z and the front side 2f of the light guide component 2 varies among the outcoupling elements 21. The first and the second outcoupling elements 21 (counted from the end face 2e) exhibit plane end faces 210 which are oriented perpendicular to the main radiation direction Z of the main lighting module 101. From the fourth outcoupling element 210 onwards, the end faces 210 are oriented parallel to the front face 2f of the light guide component 2, and the end face 210 of the third outcoupling element 21 features an intermediate orientation, i.e., an orientation which is neither parallel to the front face 2f nor perpendicular to the main radiation direction Z. By varying the orientation of the end faces 210 of the decoupling elements 21 along the light guide component 2 in this way, a beneficial light directing effect can be imparted on the light emitted by the main lighting module 101 and transmitted through the light guide component 2.

In the embodiment of FIG. 4, the light guide component 2 features an elongated, curved shape in such a way that the orientation of the front side 2f and the orientation of the plane end faces 210 of the outcoupling elements 21 vary along the elongation of the light guide component 2 with respect to the main radiation direction Z. The end faces 210 are oriented along the light guide component 2 in such a way that they always have an approximately parallel orientation to the associated, i.e., opposite section of the front face 2f of the light guide component 2.

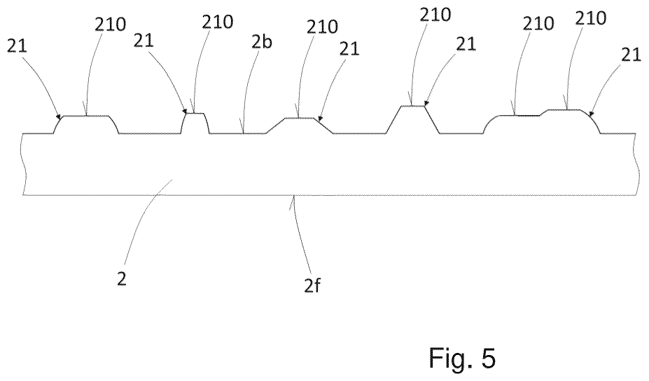

FIG. 5 shows a schematic cross-sectional view of a section of a light guide component 2 according to the invention, which exemplarily features different truncated outcoupling elements 21. Viewed from left to right, these take the shape of a truncated hemisphere, a truncated ellipsoidal segment, a truncated pyramid, a truncated cone and a truncated free-form body. For the individual adaptation of the light guide component 2 in a vehicle lighting device according to the invention, a suitable selection can be made, for example, from the shapes of the outcoupling elements 21 shown in FIG. 5. Furthermore, the dimensions, spacings and the density of the outcoupling elements 21 on the rear side 2b of the light guide component 2 can be appropriately chosen.

The body of the light guide component 2 in any of the figures can be for instance rod-shaped or plate-shaped or be given by a dedicated free-form body.

The present invention is not limited by the embodiments described above, which are represented as examples only and can be modified in various ways within the scope of protection defined by the appending patent claims.

### LIST OF NUMERALS

100 vehicle lighting device
100pa prior art vehicle lighting device
101 main lighting module
102 secondary lighting module
102pa prior art secondary lighting module
1 light source
2 light guide component
2pa prior art light guide component
2f front side
2b rear side
2e end face
21 outcoupling element
21pa prior art outcoupling element
210 end face
Z main radiation direction

We claim:

1. A vehicle lighting device comprising:
a main lighting module radiating light along a main radiation direction (Z), and
a secondary lighting module with a light source and a light guide component, the light source radiating light into the light guide component via an end face, the light guide component including outcoupling elements protruding at a rear side for light outcoupling out of an opposite front side of the light guide component,
the light guide component being arranged in front of the main lighting module such that at least a part of the light guide component is within a field of view of the main lighting module,
wherein the outcoupling elements have truncated shapes with plane end faces, the plane end faces being oriented parallel to the front side of the light guide component and/or perpendicular to the main radiation direction (Z) and/or inclined in an intermediate orientation.

2. The vehicle lighting device according to claim 1, wherein the outcoupling elements are shaped as truncated cones, truncated pyramids, truncated hemispheres, truncated ellipsoidal segments and/or truncated free-form bodies, wherein the plane end faces are formed by the truncation.

3. The vehicle lighting device according to claim 1, wherein the orientation of the plane end faces with respect to the main radiation direction (Z) and/or the front side of the light guide component varies among the outcoupling elements.

4. The vehicle lighting device according to claim 1, wherein the light guide component includes an elongated curved shape in such a way that the orientation of the front side and the orientation of the plane end faces of the outcoupling elements vary along the elongation of the light guide component with respect to the main radiation direction (Z).

5. The vehicle lighting device according to claim 1, wherein the outcoupling elements protrude at the rear side of the light guide component by a height in a range of 0.05 mm to 5 mm.

6. The vehicle lighting device according to claim 1, wherein the outcoupling elements have a lateral size in a range of 0.05 mm to 5 mm.

7. The vehicle lighting device according to claim 1, wherein the body of the light guide component is shaped as a rod, a plate, or a free-form body.

8. The vehicle lighting device according to claim 1, wherein the vehicle lighting device is a headlight and the main lighting module is a low-beam lighting module.
